(19) United States
(12) Patent Application Publication
(10) Pub. No.: US 2025/0153237 A1
(43) Pub. Date: May 15, 2025

(54) EARLY WARNING METHOD FOR FATIGUE DAMAGE STATE OF TIE ROD IN DIAMETER EXPANDING MACHINE BASED ON OIL PRESSURE OF POWER CYLINDER

(71) Applicant: HUNAN UNIVERSITY OF SCIENCE AND TECHNOLOGY, Xiangtan (CN)

(72) Inventors: Yongping JIN, Xiangtan (CN); Gan WANG, Xiangtan (CN); Deping PENG, Xiangtan (CN)

(21) Appl. No.: 19/027,526

(22) Filed: Jan. 17, 2025

(30) Foreign Application Priority Data
Mar. 5, 2024 (CN) 202410251778.3

(51) Int. Cl. B21D 41/02; F15B 19/00

(52) U.S. Cl. CPC B21D 41/02; F15B 19/00; F15B 2211/857

(57) ABSTRACT

The present disclosure describes an early warning method for assessing the fatigue damage state of a tie rod of a diameter expanding machine, based on the oil pressure of a power cylinder. (1) An oil pressure sensor is installed on the power cylinder, and collects oil pressure data in real time. (2) Required parameters are input into an early warning system. (3) A health state indicator function model of the tie rod is constructed. (4) Calculating the constant term in a linear equation allows for the construction of a tie rod S-N fatigue curve equation at a 95% confidence level. (5) A cumulative damage factor and a current health indicator of the tie rod are calculated. (6) If the early warning system determines that the current health indicator of the tie rod is 60.5 or lower, an alarm is triggered.

### CROSS-REFERENCE TO RELATED APPLICATIONS

This application claims the benefit of priority from Chinese Patent Application No. 202410251778.3, filed on Mar. 5, 2024. The content of the aforementioned application, including any intervening amendments thereto, is incorporated herein by reference in its entirety.

### TECHNICAL FIELD

This application is related to the operation monitoring of a diameter expanding machine, particularly to an early warning method for fatigue damage state of a tie rod in a diameter expanding machine based on oil pressure of a power cylinder.

### BACKGROUND

Currently, oil and gas are mainly transported through pipelines. As an essential process in the production and processing of oil-gas pipelines, diameter expanding is intended to expand the pipe blank to the expected size by using a diameter expanding machine. As the core component of the diameter expanding machine, the tie rod may develop cracks at its weak sections due to continuous operation, posing a significant security risk. As a core component of the diameter expanding machine, the tie rod may develop cracks at its weak sections due to continuous operation, posing a significant security risk. Therefore, it is of great significance and practical value to continuously monitor the operation state of the tie rod during the diameter expanding operation. At present, the operation state of the tie rod is generally monitored based on processing experience, and there is a lack of technologies that can directly reflect the fatigue damage state of the tie rod. The traditional monitoring methods need repeated detachment of the tie rod for damage detection, greatly extending the processing time and reducing the processing efficiency.

Moreover, the mechanical diameter expanding process involves the transfer of force and motion. The force state and the motion law of the diameter expanding machine are important for design of production process, optimization of design and operation parameters and component structure, and maintenance and management of equipment, and thus have attracted extensive attention. At present, the researches on the mechanical expanding process and device mainly involve design and calculation of the expanding force and stroke, and design of some components such as expanding head and tie rod, and it has been rarely reported about the systematic analysis of the whole process of mechanical expanding process and the force characteristics and motion laws of individual parts, failing to achieve the systematic test and dynamic analysis of process devices.

### SUMMARY

In view of the deficiencies in the prior art, this application provides an early warning method for fatigue damage state of a tie rod in a diameter expanding machine based on oil pressure of a power cylinder with simple and convenient operation. Moreover, the damage state of the tie rod inside the diameter expanding machine can be monitored during the practical diameter expanding process.

Technical solutions of this application are described as follows.

This application provides an early warning method for fatigue damage state of a tie rod in a diameter expanding machine based on oil pressure of a power cylinder, the diameter expanding machine comprising the tie rod and the power cylinder, the power cylinder comprising a piston, and the early warning method comprising:
(1) installing an oil pressure sensor on the power cylinder; connecting the oil pressure sensor with a microcomputer; and collecting oil pressure data of the power cylinder in real time;
(2) inputting a minimum sectional area of the tie rod, and an effective action area of the piston during diameter expanding and returning processes into an early warning system of the microcomputer;
(3) based on a linear cumulative damage theory, building a function model associated with a health state evaluation indicator of the tie rod;
(4) based on a material fatigue test of the tie rod and data analysis, calculating a fatigue strength S^{0.95} of the tie rod at a confidence level of 0.95; and calculating a constant term in a linear equation to construct a stress-number of cycles (S-N) fatigue curve equation of the tie rod at the confidence level of 0.95;
(5) based on the oil pressure data of the power cylinder at a current diameter-expanding operation, calculating a damage factor of the tie rod for the current diameter-expanding operation; calculating a cumulative damage factor of the tie rod; constructing a health indicator model of the tie rod based on the oil pressure of the power cylinder; and calculating a current health indicator of the tie rod; and
(6) determining, by the early warning system, whether the current health indicator of the tie rod obtained in step (5) is not greater than 60.5: if so, raising an alarm to an operator; otherwise, maintaining normal operation of the diameter expanding machine.

In an embodiment, in step (1), a front chamber and a rear chamber of the power cylinder are each mounted with the oil pressure sensor.

In an embodiment, in step (1), the oil pressure data of the power cylinder is collected at a frequency of 2 Hz.

In an embodiment, the function model built in step (3) is based on a 100-point scale, expressed as:

$$H = \{ \begin{matrix}100 - 40 {D}_{k} , & {D}_{k} \geq 1 \\ 40 {e}^{1 - {D}_{k}} , & {D}_{k} < 1\end{matrix} ;$$

wherein Dₖ is a cumulative damage factor of the tie rod under k types of stresses, represented by

$${D}_{k} = {\sum }_{i = 1}^{k} \frac{{n}_{i}}{{N}_{i}} .$$

In an embodiment, in step (4), the fatigue strength S^{0.95} is calculated by the following formula:

$$R = {\int }_{- ∞}^{{S}^{0.95}} \frac{1}{\sqrt{2 π σ}} {e}^{\frac{{( {S}_{x} - \overline{S} )}^{2}}{2 {σ}^{2}}} {dS}_{x} = 0 \text{.95} ;$$

wherein s̅ is an average value of a material fatigue strength of the tie rod obtained from the material fatigue test; σ² is a variance of the material fatigue strength of the tie rod; e is a base of a natural logarithm; π represents a ratio of circumference to diameter; and Sₓ is an independent variable for calculation of the material fatigue strength.

In an embodiment, the S-N fatigue curve equation constructed in step (4) is expressed as:

S^{m}N=C^{0.95};

wherein S represents a stress amplitude at a current cycle; N represents a fatigue life of the tie rod under the stress amplitude S; C^{0.95} represents the constant term in the linear equation at the confidence level of 0.95; and m represents a material coefficient of the tie rod.

In an embodiment, in step (5), the current health indicator of the tie rod is calculated through steps of:
(5.1) based on oil pressure data of a front chamber and a rear chamber of the power cylinder, calculating an action force Fⱼⁱ of the tie rod at moment i in a j-th diameter-expanding operation, expressed as:

$${F}_{j}^{i} = {A}_{y 1} {p}_{y 1}^{i , j} - {A}_{y 2} {p}_{y 2}^{i , j} ;$$

wherein p_{y1}^{i,j} represents an oil pressure value in the front chamber at the moment i in the j-th diameter-expanding operation; p_{y2}^{i,j} represents an oil pressure value in the rear chamber at the moment i in the j-th diameter-expanding operation; A_{y1} represents an effective action area of the piston in the front chamber; and A_{y2} represents an effective action area of the piston in the rear chamber;
(5.2) in the j-th diameter-expanding operation, selecting first 10 action forces of the tie rod according to a descending order; and taking an average value of the first 10 action forces as an action force of the tie rod to calculate a stress amplitude of the tie rod in the j-th diameter-expanding operation, expressed as:

$${S}_{j} = \frac{1}{10 {A}_{g}} {\sum }_{n = 1}^{10} {F}_{j}^{n} ;$$

wherein Sⱼ represents the stress amplitude of the tie rod in the j-th diameter-expanding operation; A_{g} represents a sectional area of the tie rod; and Fⱼⁿ represents an n-th selected action force of the tie rod;
(5.3) calculating a cumulative damage factor Dₖ′ of the tie rod based on oil pressure of the power cylinder after experiencing k diameter-expanding operations according to the following formula:

$${D}_{k}^{′} = \frac{1}{{c}^{0.95}} {\sum }_{j = 1}^{k} {S}_{j} ;$$

and
(5.4) obtaining the current health indicator H′ according to the following formula:

$${H}^{′} = \{ \begin{matrix}100 - 40 {D}_{k}^{′} , & {D}_{k}^{′} \geq 1 \\ 40 {e}^{1 - {D}_{k}^{′}} , & {D}_{k}^{′} < 1\end{matrix} .$$

Compared to the prior art, this application has the following beneficial effects.

The early warning method in this application is simple and easy to operate, and can solve the problem in the prior art that the damage state of the tie rod inside the diameter expanding machine cannot be monitored in real time. Based on the oil pressure in the power cylinder, the early warning method can accurately identify the damage state of the tie rod of the diameter expanding machine without repeated disassembly and assembly, thereby improving the processing efficiency, and providing an accurate warning for the fatigue damage state of the tie rod.

### BRIEF DESCRIPTION OF THE DRAWINGS

Fig. 1 is a flow chart of an early warning method of fatigue damage state of a tie rod of a diameter expanding machine based on oil pressure of a power cylinder according to one embodiment of the present disclosure;

Fig. 2 is a schematic diagram of a diameter expanding machine involved in the early warning method according to an embodiment of the present disclosure; and

Fig. 3 schematically shows collection of oil pressure in a front chamber of a power cylinder according to one embodiment of the present disclosure.

### DETAILED DESCRIPTION OF EMBODIMENTS

The disclosure will be further described in detail in conjunction with the accompanying drawings.

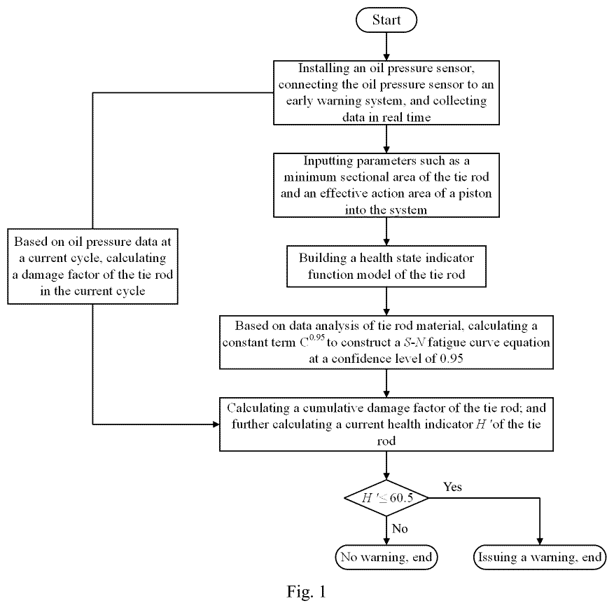

As shown in FIG. 1, an early warning method is provided for fatigue damage state of a tie rod in a diameter expanding machine based on oil pressure of a power cylinder, which includes the following steps (1)-(6). Specifically, the diameter expanding machine includes the tie rod and the power cylinder, and the power cylinder includes a piston.
(1) Oil pressure sensors are mounted in a front chamber and a rear chamber of the power cylinder of the diameter expanding machine, respectively. The oil pressure sensors are connected to a microcomputer to collect oil pressure data of the power cylinder in real time at a frequency of 2 Hz.
(2) The parameters such as the tie rod number, the minimum sectional area of the tie rod, and an effective action area of the piston during diameter expanding and returning processes are inputted in the early warning system.
(3) Based on the linear cumulative damage theory, a function model H associated with a health state evaluation indicator of the tie rod is based on a 100-point scale and expressed as

$$H = \{ \begin{matrix}100 - 40 {D}_{k} , & {D}_{k} \geq 1 \\ 40 {e}^{1 - {D}_{k}} , & {D}_{k} < 1\end{matrix} .$$

In the above formula, DR is a cumulative damage factor of the tie rod under k types of stresses.
(4) Based on a material fatigue test of the tie rod and its data analysis, the constant term in the linear equation is obtained, and the stress-number of cycles (S-N) fatigue curve equation of the tie rod at the confidence level of 0.95 is constructed and expressed as:

S^{m}N=C^{0.95}.

In the above formula, S represents a stress amplitude at a current diameter-expanding operation (current diameter-expanding cycle); N represents a fatigue life of the tie rod under the stress amplitude S; C^{0.95} represents the constant term in the linear equation at the confidence level of 0.95; and m represents a material coefficient of the tie rod.

The fatigue strength S^{0.95} is calculated by the following formula at the confidence level R of 0.95:

$$R = {\int }_{- ∞}^{{S}^{0.95}} \frac{1}{\sqrt{2 π σ}} {e}^{\frac{{( {S}_{x} - \overline{S} )}^{2}}{2 {σ}^{2}}} {dS}_{x} = 0.95 .$$

In above formula, s̅ is an average value of a material fatigue strength of the tie rod; σ² is a variance of the material fatigue strength of the tie rod obtained from the material fatigue test; e is the base of a natural logarithm; π represents a ratio of circumference to diameter; and Sₓ is an independent variable for calculation of the material fatigue strength.
(5) Based on the oil pressure data of the power cylinder at the current diameter-expanding operation, the damage factor of the tie rod for the current diameter-expanding operation is calculated. Then, the cumulative damage factor of the tie rod is calculated. The health indicator model of the tie rod based on the oil pressure of the power cylinder is built. The current health indicator of the tie rod is calculated. The specific operations are as follows.
(5.1) The action force Fⱼⁱ of the tie rod at the moment i in the j-th diameter-expanding operation of the tie rod is calculated based on the oil pressure data of the front chamber and the rear chamber of the power cylinder, and Fⱼⁱ=A_{y1}p_{y1}^{i,j}−A_{y2}P_{y2}^{i,j}.

In above formula, p_{y1}^{i,j} represents the oil pressure value in the front chamber at the moment i in the j-th diameter-expanding operation of the tie rod; p_{y2}^{i,j} represents the oil pressure value in the rear chamber at the moment i in the j-th diameter-expanding operation of the tie rod; A_{y1} represents the effective action area of the piston in the front chamber; and A_{y2} represents the effective action area of the piston in the rear chamber.
(5.2) In the j-th diameter-expanding operation of the tie rod, first 10 action forces of the tie rod are selected according to a descending order, and an average value of the first 10 action forces is taken as the action force of the tie rod to calculate a stress amplitude Sⱼ of the tie rod in the j-th diameter-expanding operation of the tie rod:

$${S}_{j} = \frac{1}{10 {A}_{g}} {\sum }_{n = 1}^{10} {F}_{j}^{n} .$$

In the above formula, Sⱼ represents the stress amplitude of the tie rod in the j-th diameter-expanding operation; A_{g} represents the sectional area of the tie rod; and Fⱼⁿ represents the n-th selected action force of the tie rod.
(5.3) The cumulative damage factor Dₖ′ of the tie rod based on oil pressure of the power cylinder after experiencing k diameter-expanding operations is obtained by the following formula:

$${D}_{k}^{′} = \frac{1}{{c}^{0.95}} {\sum }_{j = 1}^{k} {S}_{j} .$$

(5.4) The health indicator H′ of the tie rod based on the oil pressure of the power cylinder is obtained by the following formula:

$${H}^{′} = \{ \begin{matrix}100 - 40 {D}_{k}^{′} , & {D}_{k}^{′} \geq 1 \\ 40 {e}^{1 - {D}_{k}^{′}} , & {D}_{k}^{′} < 1\end{matrix} .$$

(6) The early warning system determines whether the health indicator of the tie rod obtained in step (5) is not greater than 60.5, and if yes, issue an alarm and remind the operator to pay attention to it; otherwise, it does not alarm.

The disclosure will be further described in detail in conjunction with specific embodiments.

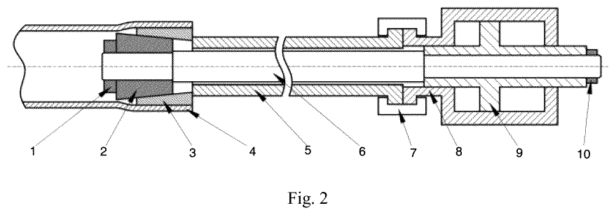

As shown in FIG. 2, the diameter expanding machine used in the present disclosure includes a diameter expanding head 2, a diameter expanding mold 3, a tie rod sleeve 5, the tie rod 6, and the power cylinder (including a cylinder body 8 and a piston 9). The piston 9 is placed in the cylinder body 8. The piston 9 is connected to the tie rod 6. The piston 9 is fixed on the tie rod 6 by means of a shaft shoulder and a nut 10. The tie rod 6 is placed in the tie rod sleeve 5, and one end of the tie rod sleeve 5 is connected to the cylinder body 8. The diameter expanding head 2 is fixed on one end of the tie rod through the nut 1. The diameter expanding head 2 cooperates with the diameter expanding mold 3.

Its working principle is as follows. When the power cylinder drives the diameter expanding head 2 to move towards the right through the tie rod 6, the diameter expanding head 2 acts on the diameter expanding mold 3 to drive the diameter expanding mold 3 to move outwardly. At the same time, the diameter-expanding force is also transmitted through the wedge-shaped cone and the diameter expanding mold, and then acted on the inner surface of a steel pipe 4, ultimately realizing a part of the steel pipe to expand. After the diameter-expanding operation is completed, the piston 9 drives the wedge-shaped cone to the left through the tie rod 6, and the force between the diameter expanding head 2 and the diameter expanding mold 3 disappears, the diameter expanding mold 3 separates from the steel pipe 4. At this time, the steel pipe 4 is not subject to force, and the tube feeding mechanism feeds the tubes step by step. Again, when the power cylinder drives the diameter expanding head 2 to move towards the right through the tie rod 6, and so on and so forth to complete the diameter-expanding operation of the whole steel tube step by step.

In the diameter-expanding process of the steel pipe, the power cylinder first pulls the diameter expanding head 2 to make the diameter expanding mold 3 expand outward, so as to expand the diameter, and then push the diameter expanding head to unlock the return stroke. This work cycle is controlled by electromagnetic directional valve of the hydraulic system.

The step (1) is performed through the following specific steps.

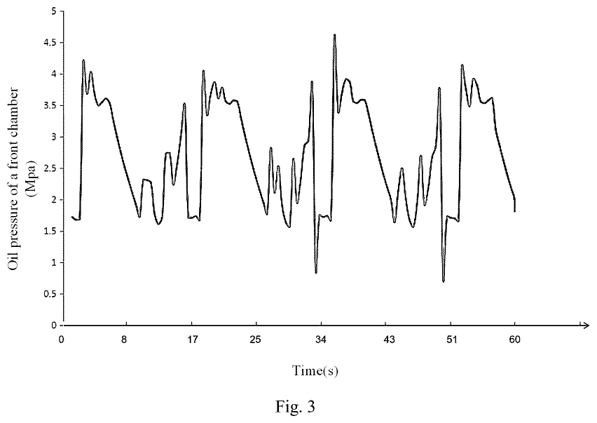

The oil pressure sensors are mounted in the front and rear chambers of the power cylinder, respectively. The displacement sensor is mounted on the piston 9. The oil pressure sensors and the displacement sensor are connected to the microcomputer. As shown in FIG. 3, the early warning system collects the oil pressure and displacement values of the power cylinder at the frequency of 2 Hz (0.5 seconds once).

The step (2) is performed through the following specific steps.

The tie rod number, the minimum sectional area of the tie rod, and the effective action area of the piston during diameter expanding and returning processes and other parameters are inputted the early warning system.

The step (3) is performed through the following specific steps.

Since the tie rod 6 is mainly subject to cycle action of the tensile stress of the diameter-expanding operation and the compressive stress of return unlocking, and the diameter-expanding force and the unlocking force are different according to different materials, different diameters, different wall thicknesses of different pipes, so the stress of the tie rod 6 is the variable-amplitude asymmetric alternating stresses. The linear cumulative damage theory can be used to assess health state of the tie rod 6. The linear cumulative damage theory assumes that: 1) under the action of equal amplitude cyclic loading, the damage to the structural member is the same for each diameter-expanding operation; 2) under the action of variable amplitude cyclic loading, the damage of different amplitudes of loads on the structural member is relatively independent, and independent of the loading sequence; and 3) when the linear cumulative value of damage caused by cyclic loading for each amplitude reaches a critical value, the structural member is damaged.

The damage factor D caused by the stress with a certain amplitude to the tie rod at one time is assumed to be:

$$D = 1 / N ;$$

where N is the fatigue life of the tie rod under the action of the stress amplitude.

When the stress spectrum of the tie rod includes k types of variable-amplitude stresses, and nᵢ cycles are experienced under the action of the i-th stress amplitude Sᵢ, the cumulative damage factor of the tie rod under k types of stresses can be expressed as:

$${D}_{k} = {\sum }_{i = 1}^{k} \frac{{n}_{i}}{{N}_{i}} ;$$

where Nᵢ is the fatigue life of the tie rod under the action of the i-th stress amplitude Sᵢ.

In summary, the function model H associated with the health state indicator of the tie rod based on the 100-point scale is expressed as:

$$H = \{ \begin{matrix}100 - 40 {D}_{k} , & {D}_{k} \geq 1 \\ 40 {e}^{1 - {D}_{k}} , & {D}_{k} < 1\end{matrix} .$$

For the tie rod, when it does not perform the diameter-expanding operation, the health indicator is 100 points. During the diameter-expanding operation of the tie rod, the larger the diameter-expanding force, the more the diameter-expanding tubes, the longer the operation time, then the greater the damage of the tie rod, and the health indicators decreases. If the tie rod has reached its expected fatigue life, the damage factor of the tie rod is 1, the health indicator is 60 points, that is, qualified level. When the tie rod beyond the expected fatigue life continues to work, the health indicator is below 60 points, and the health indicator of the tie rod decreases exponentially with the increase of the damage factor until the health indicator is infinitely close to 0.

The step (4) is performed through the following steps.

Based on the material fatigue test of the tie rod and its data analysis, the S-N fatigue curve and the probability distribution of the fatigue strength are obtained. Considering that the tie rod has a relatively simple structure, and the characteristic ratio of the cyclic stress is about −0.5, the fatigue characteristics of the tie rod material are regarded as the fatigue characteristics of the tie rod, the S-N fatigue curve of the tie rod is constructed with the confidence level of 0.95.

When the confidence level R of the tie rod is 0.95, the fatigue strength S^{0.95} is calculated by the following formula:

$$R = {\int }_{- ∞}^{{S}^{0.95}} \frac{1}{\sqrt{2 π} σ} {e}^{\frac{- {( {S}_{x} - \overline{S} )}^{2}}{2 {σ}^{2}}} {dS}_{x} = 0.95 .$$

In the above formula, s̅ is the average value of the material fatigue strength of the tie rod; σ² is the variance of the material fatigue strength of the tie rod obtained from the material fatigue test; e is the base of the natural logarithm; π represents a ratio of circumference to diameter; and Sₓ is an independent variable for calculation of the material fatigue strength.

Through the logarithmic expression of the S-N fatigue curve, the constant term C^{0.95} in the linear equation under the confidence level of 0.95 is obtained from the following formula:

$$lg {C}^{0.95} = lg {N}_{c} + m lg {S}^{0.95} ;$$

where m is the material coefficient of the tie rod; and N_{c} is the material infinite life of the tie rod under the fatigue strength of S^{0.95}, and N_{c}=1×10⁷.

The S-N fatigue curve equation of the tie rod corresponding to the confidence level of 0.95 is constructed and expressed as:

S^{m}N=C^{0.95}.

In the above formula, S represents the stress amplitude during the current diameter-expanding operation; N represents the fatigue life of the tie rod under the stress amplitude S; C^{0.95} represents the constant term in the linear equation when the confidence level is 0.95; and m represents the material coefficient of the tie rod.

The step (5) is performed through the following specific steps.

Sⱼ represents the stress amplitude of the tie rod during the j-th diameter-expanding cycle, and can be calculated based on the oil pressure data of the front and rear chambers of the power cylinder. When the inertial forces such as the inertial force of the piston are not considered, the action force Fⱼⁱ of the tie rod at the moment i in the j-th diameter-expanding operation of the tie rod is calculated by the following formula:

$${F}_{j}^{i} = {A}_{y 1} {p}_{y 1}^{i , j} - {A}_{y 2} {p}_{y 2}^{i , j} .$$

In the above formula, p_{y1}^{i,j} represents the oil pressure value in the front chamber at the moment i in the j-th diameter-expanding operation of the tie rod; p_{y2}^{i,j} represents the oil pressure value in the rear chamber at the moment i in the j-th diameter-expanding operation of the tie rod; A_{y1} represents the effective action area of the piston in the front chamber; and A_{y2} represents the effective action area of the piston in the rear chamber.

In the j-th diameter-expanding operation cycle of the power cylinder, the first 10 action forces of the tie rod (n=1, 2, 3 . . . 10) are selected according to the descending order. The average value of the 10 action forces of the tie rod (i.e., take the average value every 5 seconds, because of the frequency of 2 Hz) is taken as the action force of the tie rod in the j-th diameter-expanding operation cycle of the power cylinder, in order to calculate the stress amplitude Sⱼ of the tie rod in the j-th diameter-expanding operation:

$${S}_{j} = \frac{1}{10 {A}_{g}} {\sum }_{n = 1}^{10} {F}_{j}^{n} .$$

In the above formula, Sⱼ represents the stress amplitude of the tie rod in the j-th diameter-expanding operation; A_{g} represents the sectional area of the tie rod; and Fⱼⁿ represents the n-th selected action force of the tie rod.

Nⱼ represents the fatigue life of the tie rod corresponding to the stress amplitude Sⱼ of the tie rod in the j-th diameter-expanding operation. Based on the S-N fatigue curve equation of the tie rod at the confidence level of 0.95 obtained in step (4), the damage factor Dⱼ of the tie rod caused by this diameter-expanding operation is expressed as:

$${D}_{j} = 1 / {N}_{j} = {S}_{j} / {C}^{0.95} ;$$

At this time, if it is assumed that k diameter-expanding operations have been experienced, the tie rod has experienced k types of stresses, and then the cumulative damage factor Dₖ′ of the tie rod based on oil pressure of power cylinder is expressed as:

$${D}_{k}^{′} = \frac{1}{{C}^{0.95}} {\sum }_{j = 1}^{k} {S}_{j} .$$

The power cylinder only is subjected to higher stress cycles when expanding the tube, which will also produce fatigue damage to the tie rod. Thus, the oil pressure threshold is set, reciprocating cycle of the power cylinder below the threshold value will not be counted in the calculation of fatigue damage. Based on oil pressure data in the various cycles of the front chamber and rear chamber of the power cylinder, the health indicator H′ of the tie rod based on the oil pressure of the power cylinder is expressed as:

$${H}^{′} = \{ \begin{matrix}100 - 40 {D}_{k}^{′} , & {D}_{k}^{′} \geq 1 \\ 40 {e}^{1 - {D}_{k}^{′}} , & {D}_{k}^{′} < 1\end{matrix} .$$

The early warning system calculates the health indicator of the tie rod in each cycle (diameter-expanding operation) in real time, and displays the health indicator, the cumulative effective cycle number, and the number of reciprocating cycles of the power cylinder, etc. in the interface, and issue an alarm when the health indicator is not greater than 60.5. The alarm is arranged to remind the operator to pay attention and dismantle the tie rods in time to do further detection, evaluate and analyze the remaining service life and then treat the tie rods.

If the health indicator exceeds 60.5, there is no alarm.

What is claimed is:

1. A method for early warning of fatigue damage in a tie rod of a diameter expanding machine based on oil pressure of a power cylinder, the diameter expanding machine comprising the tie rod and the power cylinder, the power cylinder comprising a piston, and the method comprising:
(1) installing an oil pressure sensor on the power cylinder; connecting the oil pressure sensor with a microcomputer; and collecting oil pressure data of the power cylinder in real time;
(2) inputting a minimum cross-sectional area of the tie rod, and an effective action area of the piston during expansion and return processes into an early warning system of the microcomputer;
(3) based on a linear cumulative damage theory, building a function model associated with a health state evaluation indicator of the tie rod;
(4) based on a material fatigue test of the tie rod and data analysis, calculating a fatigue strength S^{0.95} of the tie rod at a 95% confidence level; and calculating a constant term in a linear equation to construct a stress-number of cycles (S-N) fatigue curve equation for the tie rod at a 95% confidence level;
(5) based on the oil pressure data of the power cylinder at a current diameter-expanding operation, calculating a damage factor for the tie rod during the current diameter-expanding operation; calculating a cumulative damage factor for the tie rod; constructing a health indicator model for the tie rod based on the power cylinder's oil pressure; and calculating a current health indicator for the tie rod; and
(6) determining, by the early warning system, whether the current health indicator of the tie rod obtained in step (5) is not greater than 60.5: if so, raising an alarm to an operator; otherwise, maintaining normal operation of the diameter expanding machine.

2. The method of claim 1, wherein in step (1), a front chamber and a rear chamber of the power cylinder are each mounted with the oil pressure sensor.

3. The method of claim 1, wherein in step (1), the oil pressure data of the power cylinder is collected at a frequency of 2 Hz.

4. The method of claim 1, wherein the function model built in step (3) is based on a 100-point scale, expressed as:
$$H = \{ \begin{matrix}100 - 40 {D}_{k} , & {D}_{k} \geq 1 \\ 40 {e}^{1 - {D}_{k}} , & {D}_{k} < 1\end{matrix} ;$$
wherein Dₖ is a cumulative damage factor of the tie rod under k types of stresses.

5. The method of claim 4, wherein in step (4), the fatigue strength S^{0.95} is calculated by the following formula:
$$R = {\int }_{- ∞}^{{S}^{0.95}} \frac{1}{\sqrt{2 π} σ} {e}^{\frac{- {( {S}_{x} - \overline{S} )}^{2}}{2 {σ}^{2}}} {dS}_{x} = 0.95 ;$$
wherein s̅ is an average value of a material fatigue strength of the tie rod obtained from the material fatigue test; σ² is a variance of the material fatigue strength of the tie rod; e is a base of a natural logarithm; π represents a ratio of circumference to diameter; and Sₓ represents the material fatigue strength.

6. The method of claim 5, wherein the S-N fatigue curve equation constructed in step (4) is expressed as:
S^{m}N=C^{0.95};
wherein S represents a stress amplitude at a current cycle; N represents a fatigue life of the tie rod under the stress amplitude S; C^{0.95} represents the constant term in the linear equation at the confidence level of 0.95; and m represents a material coefficient of the tie rod.

7. The method of claim 6, wherein in step (5), the current health indicator of the tie rod is calculated through steps of:
(5.1) based on oil pressure data of a front chamber and a rear chamber of the power cylinder, calculating an action force Fⱼⁱ applied by the power cylinder to the tie rod at moment i in a j-th diameter-expanding cycle, expressed as:
$${F}_{j}^{i} = {A}_{y 1} {p}_{y 1}^{i , j} - {A}_{y 2} {p}_{y 2}^{i , j} ;$$
wherein p_{y1}^{i,j} represents an oil pressure value in the front chamber at the moment i in the j-th diameter-expanding cycle; p_{y2}^{i,j} represents an oil pressure value in the rear chamber at the moment i in the j-th diameter-expanding cycle; A_{y1} represents an effective action area of the piston in the front chamber; and A_{y2} represents an effective action area of the piston in the rear chamber;
(5.2) in the j-th diameter-expanding cycle, selecting first 10 action forces of the tie rod according to a descending order; and taking an average value of the first 10 action forces as an action force of the tie rod to calculate a stress amplitude of the tie rod in the j-th diameter-expanding cycle, expressed as:
$${S}_{j} = \frac{1}{10 {A}_{g}} {\sum }_{n = 1}^{10} {F}_{j}^{n} ;$$
wherein Sⱼ represents the stress amplitude of the tie rod in the j-th diameter-expanding cycle; A_{g} represents a sectional area of the tie rod; and Fⱼⁿ represents an n-th selected action force of the tie rod;
(5.3) calculating a cumulative damage factor Dₖ′ of the tie rod based on the oil pressure of the power cylinder after experiencing k diameter-expanding operations according to the following formula:
$${D}_{k}^{′} = \frac{1}{{C}^{0.95}} {\sum }_{j = 1}^{k} {S}_{j} ;$$
and
(5.4) obtaining a value of the current health indicator H′ according to the following formula:
$${H}^{′} = \{ \begin{matrix}100 - 40 {D}_{k}^{′} , & {D}_{k}^{′} \geq 1 \\ 40 {e}^{1 - {D}_{k}^{′}} , & {D}_{k}^{′} < 1\end{matrix} .$$
